(19) United States
(12) Patent Application Publication
(10) Pub. No.: US 2004/0171475 A1
(43) Pub. Date: Sep. 2, 2004

(54) Method for regenerating the oxidation catalyzer of the exhaust gases of an internal combustion engine

(76) Inventors: Jacob Klimstra, Twyzel (NL); Kristoffer Sandelin, Vaasa (FI); Jan Torrkulla, Vora (FI)

Correspondence Address: SMITH-HILL AND BEDELL, 12670 N W BARNES ROAD, SUITE 104, PORTLAND, OR, 97229

(21) Appl. No.: 10/770,621

(22) Filed: Feb. 2, 2004

(30) Foreign Application Priority Data
Feb. 6, 2003 (FI) 20030196

(51) Int. Cl. B01J 38/04

(52) U.S. Cl. 502/34

(57) ABSTRACT

In operation of an internal combustion engine, exhaust gases of the internal combustion engine are directed through an oxidation catalyzer and thereby heat the catalyzer. Subsequently the engine is stopped, and the catalyzer is regenerated by supplying reducing gas to the catalyzer while the catalyzer is still sufficiently hot for regeneration to occur.

### BACKGROUND OF THE INVENTION

This invention relates to a method for regenerating the oxidation catalyzer of the exhaust gases of an internal combustion engine.

Oxidation catalyzers are used for oxidizing the hydrocarbons contained in exhaust gases from various processes. For example, exhaust gases from internal combustion engines can contain various unburned hydrocarbons. Catalyzers are commonly used for oxidizing hydrocarbons prior to releasing the exhaust gases to the atmosphere. Catalyzers are, however, delicate, and they can be contaminated, i.e. their working capacity can be reduced, due to the presence of certain substances. Oxidation catalyzers are especially prone to sulphur contamination. It is, however, known that in reducing conditions hydrogen (H₂) can react with sulphur, forming H₂S. Removal of sulphur in this manner may restore the operating capacity of the catalyzer.

In a large engine, it is difficult to regenerate the exhaust gas oxidation catalyzer. In other words, it is difficult to restore the operating capacity of the catalyzer. The running period of a large engine may be long and the exhaust gases are not reducing gases, at least not to a sufficient degree to remove sulphur effectively from the catalyzer.

It is an object of the invention to provide an arrangement and a method for considerably improving the operation of an oxidation catalyzer especially of large engines.

### SUMMARY OF THE INVENTION

In accordance with the present invention there is provided a method of operating an internal combustion engine having an oxidation catalyzer, comprising operating the engine and directing exhaust gases of the internal combustion engine through the oxidation catalyzer and thereby heating the catalyzer, and subsequently stopping the engine and regenerating the catalyzer by supplying reducing gas to the catalyzer while the catalyzer is still sufficiently hot for regeneration to occur.

Regenerating an oxidation catalyzer requires a sufficiently high temperature. In an embodiment of the present invention, the heat accumulated in the catalyzer during normal operation of the engine is used for the regeneration.

In a method embodying the invention, the temperature of the oxidation catalyzer may be measured and the temperature information read by a control apparatus, under control of which the flow of reducing gas into the oxidation catalyzer is stopped when the temperature of the oxidation catalyzer falls below a certain set value.

In a preferred method embodying the invention, the oxidation catalyzer may also be at least partially regenerated from time to time during normal running of the engine by reducing the amount of engine exhaust gas flowing through the catalyzer in comparison to normal running situation and bringing reducing gas into contact with the catalyzer.

Reducing gas may produced by a separate arrangement for producing reducing gas. The detailed way of actually producing the reducing gas is not essential as far as the invention is concerned, but various solutions can be used for this. In accordance with one possibility, the arrangement for producing reducing gas comprises a fuel source and a fuel reformer for producing reducing gas from the fuel by incomplete oxidation of the fuel.

In an application of a preferred embodiment of the invention, a by-pass channel is connected to the exhaust gas channel of the engine for by-passing the oxidation catalyzer, whereby exhaust gas can be directed past the oxidation catalyzer. In addition, in this case an arrangement for producing reducing gas is connected to the exhaust gas channel between the branch of the by-pass channel, which is located upstream of the catalyzer with respect to the flow direction of the gas, and the oxidation catalyzer. The arrangement for producing reducing gas is preferably connected to the exhaust gas channel via a first closing means or valve and the first closing means is preferably functionally connected to a control apparatus for controlling the first closing means. The by-pass channel is provided with a second closing means or valve and the exhaust gas channel is provided with a third closing means or valve, the second and third closing means also being functionally connected to the control apparatus.

### BRIEF DESCRIPTION OF THE DRAWING

In the following, an example of the invention is explained, with reference to the appended drawing, in which the single figure is a schematic illustration an arrangement embodying the invention.

### DETAILED DESCRIPTION

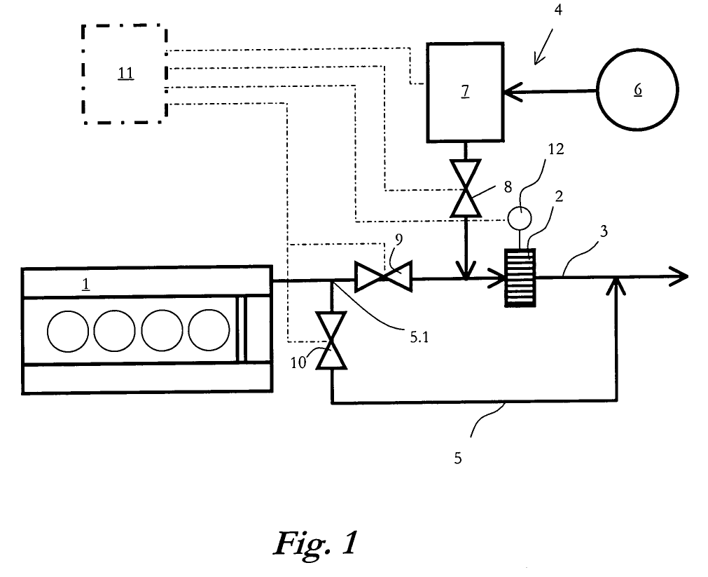

FIG. 1 shows a regeneration arrangement in which an oxidation catalyzer 2 for hydrocarbons contained in exhaust gases is connected to the exhaust gas channel 3 of an internal combustion engine 1. In normal operation, the catalyzer oxidizes the hydrocarbons contained in the exhaust gases. The arrangement further comprises an arrangement 4 acting as a source of reducing gas, the arrangement comprising a fuel source 6, such as a tank, and a fuel reformer 7, by means of which, for example, an incomplete oxidation process of fuel can be carried out. The fuel reformer 7 is connected to the exhaust gas channel 3 at a location upstream of the oxidation catalyzer 2 with respect to the direction of gas flow by a first valve 8, whereby the flow of reducing gas into the exhaust gas channel can be controlled as desired. The control is carried out by means of a control apparatus 11. The arrangement also comprises a by-pass channel 5 for bypassing the oxidation catalyzer 2, whereby the reformer 7 is connected to the exhaust gas channel 3 at a location between the branch 5.1 of the by-pass channel 5, located upstream of the catalyzer with respect to the flow direction of the gas, and the oxidation catalyzer 2. The by-pass channel 5 is provided with another valve 10, which is functionally connected to the control apparatus 11. The exhaust gas channel 3 is provided with a third valve 9 downstream of the branch of the by-pass channel, the valve 9 being functionally connected to the control apparatus 11.

The temperature of the oxidation catalyzer 2 is measured by a sensor 12 and the temperature information read by the control apparatus 11.

During normal operation of the internal combustion engine the exhaust gases are directed through the oxidation catalyzer 2. It is possible that the oxidation catalyzer will deteriorate with age due to contamination. Sulphur contamination in particular is typical for oxidation catalyzers. In this event its capability of catalyzing desirable reactions will be considerably reduced.

It is normal that the engine will be stopped from time to time. In order to restore the operating capacity of the catalyzer, the oxidation catalyzer 2 is regenerated by directing reducing gas into contact with the catalyzer after the engine has been turned off, whereby heat accumulated by the catalyzer during normal operation of the engine is used in the regeneration reaction. Thus, the valve 8 is opened after stopping the engine for directing reducing gas into the catalyzer 2.

Reducing gas can be directed to the catalyzer 2 either until regeneration has been completed or until it can be seen from the temperature measurement that the temperature has fallen too low for regeneration to happen.

In order to minimize loss of operating capacity of the catalyzer while the engine is running, the oxidation catalyzer 2 may be at least partially regenerated from time to time by directing reducing gas into contact with the catalyzer while the engine is running. This is accomplished by reducing the amount of the engine exhaust gas flowing through the catalyzer in comparison to normal running conditions. To achieve this, the control apparatus 11 is used for closing the valve 9 and opening the valve 10. Thereby the exhaust gases of the engine 1 flow through the by-pass channel 5 and the flow to the oxidation catalyzer is terminated. The valve 8 is opened at this phase at the latest. Thus, reducing gas can flow into the oxidation catalyzer 2 and the catalyzer can be regenerated while the engine is running.

The invention is not limited to the embodiment described here, but a number of modifications thereof can be conceived of within the scope of the appended claims.

1. A method of operating an internal combustion engine having an oxidation catalyzer, comprising:
operating the engine and directing exhaust gases of the internal combustion engine through the oxidation catalyzer and thereby heating the catalyzer, and
subsequently stopping the engine and regenerating the catalyzer by supplying reducing gas to the catalyzer while the catalyzer is still sufficiently hot for regeneration to occur.

2. A method according to claim 1, comprising measuring the temperature of the oxidation catalyzer and controlling supply of reducing gas to the catalyzer in dependence on the measured temperature of the catalyzer.

3. A method according to claim 2, comprising comparing the measured temperature of the catalyzer with a datum value and terminating supply of reducing gas to the catalyzer when the measured temperature falls below the datum value.

4. A method according to claim 1, comprising producing the reducing gas by a process that is independent of operation of the engine.
